(19) United States
(12) Patent Application Publication
(10) Pub. No.: US 2026/0214298 A1
(43) Pub. Date: Jul. 23, 2026

(54) Management of the provision of multimedia content segment addresses

(71) Applicant: ORANGE, ISSY LES MOULINEAUX (FR)

(72) Inventors: Hervé MARCHAND, Chatillon (FR); Mathieu RIVOALEN, Chatillon (FR)

(21) Appl. No.: 19/139,015

(22) PCT Filed: Dec. 4, 2023
(86) PCT No.: PCT/EP2023/084142

§ 371 Date: Jun. 13, 2025

(30) Foreign Application Priority Data
Dec. 16, 2022 (FR) FR2213685

(51) Int. Cl. H04N 21/4402; H04N 21/6377; H04N 21/845

(52) U.S. Cl. CPC H04N 21/440281; H04N 21/6377; H04N 21/8456

(57) ABSTRACT

A method for managing the provision of manifests associated with segments of a segmented content item, the manifests, referred to as first manifests, including content segment addresses and being transmitted consecutively in succession with a view to being played back by a playback device. The method includes: during the transmission of the content item in real time, receiving, from a playback device, a command to carry out a time hop in the content item in order to play back the content item from a time earlier than the current playback time, the receiving triggering a transmission of a second manifest comprising addresses of segments to be played back at said earlier time, supplemented with some of the addresses of segments of the content item that have already been transmitted.

### TECHNICAL FIELD

The field of the invention is that of managing the provision of addresses of chunks of multimedia content to a content playback device.

The invention most particularly targets chunked content, the chunks being accessible in several formats associated with respective sizes in bytes having more or less impact on the bandwidth of the network over which the content is downloaded. The invention most particularly targets content downloaded using a technique referred to as HTTP adaptive streaming, or HAS, or any other download techniques using the same principle.

### PRIOR ART

When content is accessed, a playback device generally sends a request to a server, indicating the chosen content; the playback device receives in return a stream of digital data relating to this content. In the context of a local area communication network, such a request transits via the access gateway to the network, for example the residential gateway.

The playback device is designed to receive digital content in the form of multimedia data and to request for this content to be rendered on a rendering device. Data received corresponding to a video are generally decoded, then rendered in the form of displaying the corresponding video with its associated soundtrack. Below, for the sake of simplicity, the digital content will be identified with a video and being rendered by the playback device, or consumed by the user of the playback device, with being viewed on the screen of the playback device.

The broadcasting of digital content over the Internet is often based on client-server protocols of the HTTP (Hypertext Transport Protocol) family. In particular, streaming digital content makes it possible to transport and consume data in real time, that is to say that the digital data are transmitted over the network and rendered by the playback device as they arrive. The playback device receives and stores a portion of the digital data in a buffer before rendering them. This distribution mode is particularly useful when the bit rate which is available to the user is not guaranteed to be enough for real-time transfer of the video.

HTTP adaptive streaming, abbreviated to HAS, additionally makes it possible to broadcast and receive data at various qualities corresponding, for example, to various bit rates. These various qualities are described in a manifest which is available to download from a data server, for example a content server. When the client playback device desires to access content, this manifest makes it possible to select the correct format for the content to be consumed depending on the available bandwidth or on the storage and decoding capacities of the client playback device. This type of technique notably makes it possible to take account of variations in bandwidth on the link between the client playback device and the content server.

There are several technical solutions for making it easier to distribute such content through streaming, such as, for example, the proprietary solutions Microsoft® Smooth Streaming, Apple® HLS, Adobe® HTTP Dynamic Streaming or indeed the MPEG-DASH standard of the ISO/IEC organization, which will be described below. These methods propose to address one or more intermediate manifests to the client, which contain the addresses of the various chunks at the various qualities of the multimedia content.

A start-over (or restart) function makes it possible for a user watching content broadcast in real time (a live channel) to select a playback instant over a given time window; this function notably makes it possible to replay content from the start. A time window is useful, in particular, for digital content referred to as live, i.e. which corresponds to real-time television programs, which do not, by nature, have a predefined duration or end date. In this scenario, the playback device receives a command to perform a time jump in the content in order to play back the content, for example a television broadcast, from an earlier instant than the current playback instant. For example, if a movie starts at 21:00 and the user switches to the channel at 21:40, they may ask for playback of the content to resume from the start of the movie by activating the mode referred to as the restart mode. In this case, a move is made from a real-time playback mode to a restart mode.

When this user accesses the live stream broadcast via HTTP adaptive streaming (HAS), the playback device retrieves at regular intervals, in general every two seconds, a manifest which generally describes the last sixty seconds of the stream (30 chunks of 2 seconds) by providing addresses of chunks corresponding to these last sixty seconds. It can then be decided to store a certain portion of the stream (here up to 60 seconds at most) in a buffer. The video chunks are of short duration because there is a desire to be as close to live as possible. It is also for this reason that the manifest is retrieved every two seconds and that buffer depth is in general limited to about fifteen seconds.

When a switch is made to the mode referred to as the restart mode, therefore to the on-demand playback mode, the manifest which is retrieved no longer describes the last sixty seconds but a time window of several hours, for example the last four hours (in case there is a desire to be able to access the last 4 hours of the live channel). The size of the manifest is therefore multiplied by two hundred and forty (240) and the playback time (or parsing time for a person skilled in the art) of the manifest, most of the time in XML format, becomes a real problem. Indeed, it is necessary, as when the stream is being played back in real time, to retrieve the manifest periodically every two seconds and, at each retrieval, scan the whole of the manifest which comprises a very large number of addresses of video and audio chunks.

One solution could consist in reducing the time window, for example to two hours instead of four hours. In this case, the service rendered to the user is greatly degraded because they are not guaranteed to be able to return, for example, to the start of the movie which they are watching.

The invention aims to improve the situation.

### THE INVENTION

The invention relates to a method for managing the provision of manifests associated with chunks of chunked content, the manifests, referred to as first manifests, comprising addresses of chunks of the content and being successively transmitted one after the other with a view to being played back by a playback device, characterized in that it comprises, during the transmission of the content in real time, a step of receiving a command to perform a time jump in the content in order to play back the content from an earlier instant than the current playback instant, the reception step triggering a step of transmitting a second manifest comprising addresses of chunks to be played back at said earlier instant, which are supplemented by a portion of the addresses of chunks of the content already having been transmitted.

The invention makes it possible, when a time jump request is made, to transmit not a complete manifest comprising all the addresses of chunks which have been broadcast as in the prior art but a subset of addresses of chunks of the complete manifest. In other words, the manifest transmitted is incomplete and comprises only a portion of the addresses of chunks which will be judiciously chosen, as will be seen below.

It is understood that the manifest created is greatly reduced in size with respect to that of the prior art because it ultimately contains only addresses of chunks to be played back, just like for a conventional playback, and at best a few other addresses of chunks, as will be seen in the remainder of the description. Indeed, it will be seen in the following description that the manifest created according to the invention describes only a few minutes (three minutes, for example) of description of the chunks, whereas a complete manifest can describe hours, for example four hours.

Also, the time taken to retrieve a chunk in the manifest, which is one subject of the invention, is fast because of the very small number of addresses of chunks comprised in the second manifest received; the time taken to transmit such a manifest over the network is also advantageous in terms of bandwidth because of its reduced size.

According to a first embodiment of the method, the portion of addresses includes addresses of chunks transmitted in the last manifest, referred to as the first manifest, in connection with the real-time playback. This embodiment makes it possible to return to live without delay because it avoids requesting the first manifest linked to the return to live.

According to another, second particular embodiment of the invention, which can be implemented as an alternative or in addition to the previous one, the portion of addresses of chunks includes chunks chosen from among the first chunks of the content. Just like the previous embodiment, this embodiment makes it possible, from the current playback instant, in restart mode, to request to resume from the start without delay because the addresses of these chunks are present in the second manifest. It will be seen below that the chunks chosen from among the first chunks target the oldest chunks which are accessible in the proposed time window. For example, if the restart mode makes it possible to return to a time window of a few hours, for example four hours in the past, the oldest chunks are the oldest chunks in this four-hour time window.

When the portion of addresses includes both the addresses targeted in the first embodiment and addresses targeted in the second embodiment, a progress bar (or timeline) can be restored in order to locate the current playback instant in time and make it possible to select an earlier or later playback instant from this progress bar and to continue playback from the selected instant.

According to another, third particular embodiment of the invention, which can be implemented as an alternative or in addition to the preceding ones, the second manifest is updated over time; in particular, the last addresses of chunks associated with the stream transmitted in real time are updated. Each update makes it possible to return to the stream transmitted in real time without having to receive a request for access to the first manifest for access to the content broadcast in real time.

According to another, fourth particular embodiment of the invention, which can be implemented as an alternative or in addition to the preceding ones, selecting, from the second manifest, one of the last addresses of chunks results in transmission of a first manifest, instead of the second manifest. This fourth embodiment makes it possible to automatically return to the real-time playback mode. This embodiment makes it possible to return to the normal mode and therefore to return to the first manifests, which are smaller in size than the second manifest.

According to another, fifth particular embodiment of the invention, which can be implemented as an alternative or in addition to the preceding ones, the earlier instant is selected in a given time window, and the portion of the other addresses of chunks of the content having been transmitted originates from this time window.

According to a variant of this fifth embodiment, the time window has a fixed duration. This embodiment is advantageous when the content does not have a predefined start instant; this is the case for most content transmitted in real time, as explained below.

When the content has a start time which is defined, in this case a time window the duration of which varies in time depending on the start time of the content under consideration can be provided.

According to one hardware aspect, the invention relates to an entity for managing the provision of manifests associated with chunks of chunked content, the manifests, referred to as first manifests, comprising addresses of chunks of the content and being successively transmitted one after the other with a view to being played back by a playback device, characterized in that it comprises a microprocessor configured to, during the transmission of the content in real time, perform a step of receiving a command to perform a time jump in the content in order to play back the content from an earlier instant than the current playback instant, this reception step triggering a step of transmitting a second manifest comprising addresses of chunks to be played back at said earlier instant, which are supplemented by a portion of the addresses of chunks of the content already having been transmitted.

According to another hardware aspect, the invention relates to a playback terminal comprising a management entity as defined above.

According to another hardware aspect, one subject of the invention is a computer program which is able to be implemented on a management entity as defined above, the program comprising code instructions which, when it is executed by a processor, performs the steps of the management method which are defined above.

According to another hardware aspect, one subject of the invention is a data medium on which at least one series of program code instructions for executing a management method as defined above has been stored.

The medium in question may be any entity or device which is capable of storing the program. For example, the medium may comprise a storage means, such as a ROM, for example a CD-ROM or a microelectronic circuit ROM, or indeed a magnetic storage means, for example a hard disk. On the other hand, the information medium may be a transmissible medium such as an electrical or optical signal, which may be routed via an electrical or optical cable, by radio or by other means. The program according to the invention may, in particular, be downloaded over the Internet. Alternatively, the information medium may be an integrated circuit into which the program is incorporated, the circuit being adapted to execute or to be used in the execution of the method in question.

The invention will be better understood on reading the following description, which is given by way of example and with reference to the appended drawings, in which:

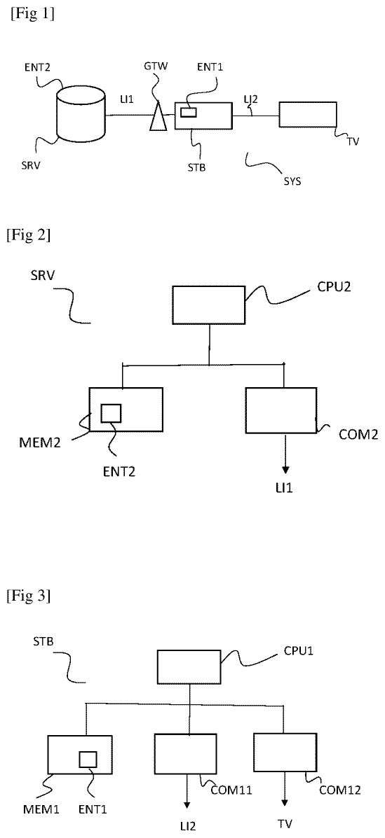

FIG. 1 depicts an architecture for streaming over the Internet based on the use of HTTP adaptive streaming according to one embodiment of the method of the invention;

FIG. 2 schematically illustrates the hardware structure of a server which is able to transmit manifests;

FIG. 3 schematically illustrates the hardware structure of a playback device which is able to play back multimedia streams in real time;

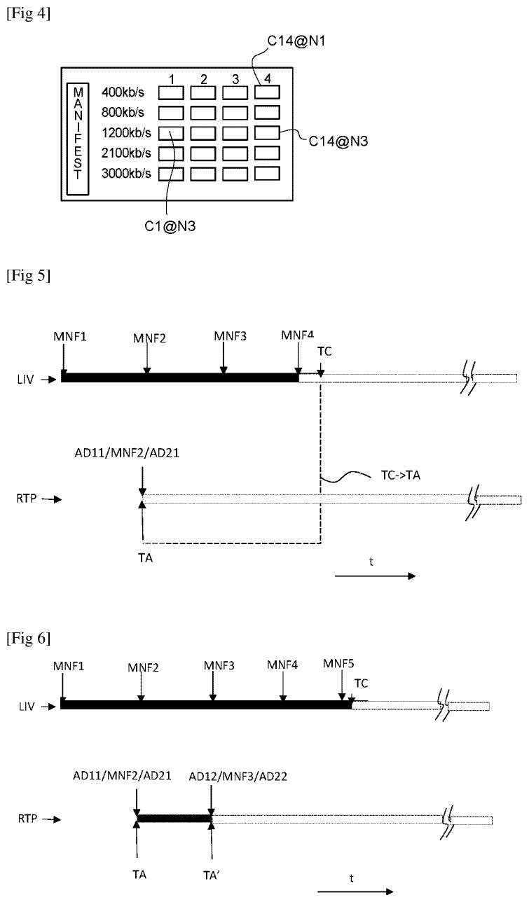

FIG. 4 illustrates content and the available chunks for this content.

FIG. 5 illustrates the state of the playback at a given instant when the restart mode is executed; it will be seen, in particular, that, during this mode, the management entity implements an algorithm to generate a manifest which is specific to the restart playback mode.

FIG. 6 illustrates the state of the playback at an instant other than that described with reference to FIG. 5 and always during playback in restart mode.

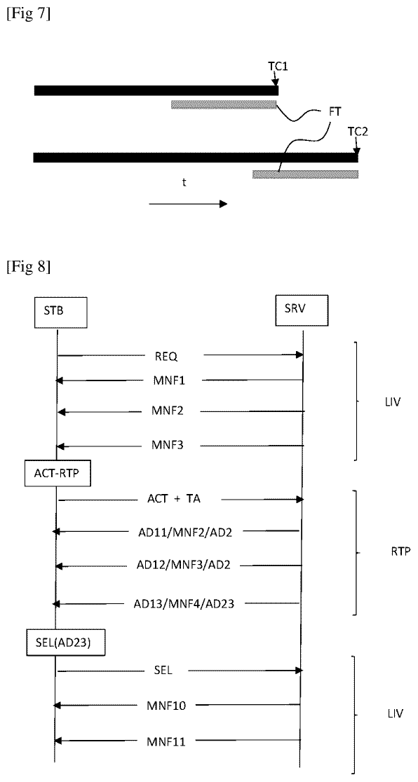

FIG. 7 schematically illustrates a time window implemented from which said portion of the other addresses of chunks of the content having been transmitted originates, which are added to the addresses of chunks to be played back at said earlier instant, to ultimately form a second manifest.

FIG. 8 illustrates steps of one embodiment.

### DETAILED DESCRIPTION OF EMBODIMENTS OF THE INVENTION

FIG. 1 depicts a computer system SYS in which a content distribution network (CDN) is implemented from which content is transmitted to client devices or content playback devices and manifests associated with the multimedia content are transmitted.

In the present example, the system comprises a single playback device STB. However, the invention applies to any number of playback devices.

The playback device is, for example, a digital playback device.

The multimedia content targeted here is video content corresponding, for example, to a television channel on which television programs having a start time corresponding to a scheduled broadcast time and an end time are broadcast. The content in question is broadcast in multicast mode.

The playback device STB is connected to a rendering terminal TV such as a television.

In the present example, the playback device STB is connected to a port of the rendering device TV; the playback device STB and the rendering device TV could also form one and the same device.

In the present example, the playback device STB is located in a local area network LAN managed by a residential gateway GTW. The context of the local area network is given by way of example and could easily be transposed to a best-effort Internet network, a business network etc.

The gateway GTW is able to communicate via a telecommunications network LI1 such as a wide area network WAN known to a person skilled in the art.

The computer system SYS implements a content distribution network (CDN) from which content is transmitted to client devices or content playback devices STB.

The CDN consists of servers networked in the wide area network; these servers interact in order to make multimedia content available to the users in unicast mode. In order to simplify the disclosure of the invention, a single content server SRV is depicted in FIG. 1 to depict the CDN. The content server SRV is located, in the present example, in the wide area network WAN.

The content server SRV receives, for example, channels of digital-television content originating from a television broadcast network (not depicted) and makes them available to client terminals, here the playback device STB, in real time.

The content CNT is made available in unicast mode in a given format. Such content CNT is, for example, content downloaded in HTTP adaptive streaming mode. The MPEG-DASH (dynamic adaptive streaming over HTTP) standard is a format standard for audiovisual broadcast over the Internet; this standard is based on preparing the content in various representations of variable quality and bit rate, which are divided into chunks of short duration (of about a few seconds). Each of these chunks is made available individually by means of a protocol for exchange between the rendering terminal and the server providing multimedia content. The protocol mainly targeted is the HTTP protocol, but other protocols (for example FTP) may also be used. The organization of the chunks and the associated parameters are published in a manifest in XML format. The details of this download mode will not be entered into further since they are not of interest to the disclosure of the invention.

FIG. 2 the server SRV is also equipped with at least one processor CPU2 and with memories MEM2 for carrying out information processing. The server is also equipped with a management entity ENT2, referred to as the first entity, which is able to manage the transmission of content and of the manifest associated with the content from the server SRV to one or more playback devices. The server SRV communicates with the gateway GTW via a WAN. The server comprises, for communication with the WAN, a communication module referenced COM2 in FIG. 3. The transmission of the manifest rather than the transmission of the chunks will primarily be focused on below.

FIG. 3 depicts an architecture of a playback device STB. This device STB conventionally comprises memories MEM1 associated with a processor CPU1. The memories may be read-only memories (ROMs) or random-access memories (RAMs) or indeed flash memories.

The playback device STB may transmit content to be rendered to the rendering device TV via a communication module COM12. This module COM12 is, for example, an HDMI link.

The playback device STB communicates with the gateway via an Ethernet module for wired local communication or via a Wi-Fi radio module for wireless local communication with the residential gateway GTW. The module in question is referenced CMO11 in FIG. 2.

The playback device STB comprises a streaming entity (not depicted) which is able to manage the downloading of chunks of the content. The playback device STB also comprises a management entity ENT1, referred to as the second management entity below, which is able to read a manifest constructed specifically during playback in restart mode, as explained below.

A schematic view of main content C1 divided into chunks and stored in the content server SRV is now presented in relation to FIG. 4. More specifically, the HAS content server offers a video C1 in the form of chunks C1i@Nj which are encoded at various encoding rates Nj, where the index i designates a temporal identifier of the chunk C1i@Nj.

The HAS module, called the conventional download mode below, of the playback device STB is responsible for retrieving the chunks from the HAS content server, choosing the video quality Nj depending on the network resources available. The way in which the HAS module chooses the encoding rate for the next video chunk to be downloaded is not described in more detail here: indeed, there are many algorithms which make it possible to make this choice, the strategies of which are more or less safe or aggressive. It will, however, be recalled that, more often than not, the general principle of such algorithms is based on downloading a first chunk at the lowest encoding rate proposed in the manifest, and on evaluating the time taken to retrieve this first chunk. On this basis, the HAS module evaluates whether, depending on the size of the chunk and on the time taken to retrieve it, the network conditions make it possible to download the following chunk at a higher encoding rate. Certain algorithms are based on a gradual increase in the quality level of the downloaded chunks of content; others propose riskier approaches, with jumps in the levels of the encoding rates for the successive chunks.

In the conventional case, if a video chunk lasts three seconds, it must not take the HAS module more than 3 seconds to retrieve the chunk, in order to make it possible for the playback device STB to render the content without interruption. It is therefore necessary for the HAS module to make the best compromise between the highest possible rendering quality, and therefore the highest possible encoding rate, and the time taken to download the chunk, which must be short enough to make continuous rendering on the television TV possible.

In a first stage, the HAS module retrieves the manifest which corresponds to the video content C1 in order to discover the available chunks of the video content C1, and the various associated video qualities Nj. In the example of FIG. 4, the content C1 is, for example, shown in the form of chunks of a duration of 3 s, with a first encoding rate N1=400 kb/s, a second encoding rate N2=800 kb/s, a third encoding rate N3=1200 kb/s, etc.

In a normal operating mode, which is not illustrated in FIG. 4, the HAS module downloads, for example, the successive chunks C11@N1 (i.e. the first time chunk at an encoding rate of 400 kb/s), then C12@N3 (i.e. the second time chunk at an encoding rate of 1200 kb/s), then C13@N3 (i.e. the third time chunk at an encoding rate of 1200 kb/s), etc.

The various chunks downloaded by the HAS module are then transmitted to a display module AFF which is able to request for them to be displayed on a screen of the television TV.

The algorithm implemented by the HAS module to determine which chunk must be downloaded at which encoding rate in normal operating mode may be one of the algorithms which already exist in the prior art. This algorithm will therefore not be described in more detail here.

It happens that sometimes the start of a television program (movie, series etc.) is missed. A function called “start-over” or “restart” makes it possible to resume, at any moment, the program in the process of being broadcast at an earlier instant than the current instant; for example, playback of the content may be resumed from its beginning. For example, if a movie starts at 21:00 and the user switches to the channel at 21:40, they may request for playback of the content to resume from the start of the movie. In this case, a move is therefore made from a real-time (or live) content playback mode to an on-demand playback mode.

When this user accesses a live stream broadcast live via HTTP adaptive streaming (HAS), the playback device STB, meaning the HAS entity installed on this device, retrieves, in general every 2 seconds, a manifest which generally describes the last 60 seconds of the stream (30 chunks of 2 seconds). It may then be decided to buffer a certain portion of the stream (up to 60 seconds maximum, therefore); the video chunks are of short duration because there is a desire to be as close to truly live as possible. It is also for this reason that the manifest is retrieved every 2 seconds and that the buffer depth is in general limited to about 15 seconds.

In the prior art, when a switch is made to restart (or start-over) mode, the manifest which is retrieved no longer describes the last sixty seconds but a time window which is much longer than sixty seconds. The time window may relate to the last four hours; in this case, if the content may be played back from an instant located in the time window. The size of the manifest is therefore multiplied by two hundred and forty (240) and the parsing time of the XML file becomes a real problem. Indeed, it is necessary, as when the live stream is being played back, to retrieve this manifest periodically every 2 seconds and, at each retrieval, scan (or parse) the whole of the manifest which comprises a very large number of tags describing video and audio chunks.

The method of the invention comprises, during the broadcasting of the content in real time, a step of receiving, from the playback device, a command to perform a time jump in the content to play back the content from an earlier instant than the current playback instant, the reception step triggering a step of transmitting a second manifest comprising addresses of chunks to be played back at said earlier instant, which are supplemented by a portion of the other addresses of chunks of the content having been transmitted.

It will be seen below that, according to one variant, the earlier instant is selected in a given time window preceding the current instant. It will also be seen that the portion of addresses is chosen in this time window.

In other words, when the restart function is activated, the management entity ENT2 installed on the server creates a manifest which is specific to the restart playback mode comprising not only addresses of chunks to be played back corresponding to the desired playback instant but also a portion of the other addresses of chunks of the content having been transmitted all along the given time range, for example, the last four hours.

The size of the manifest thus created is therefore reduced since the manifest does not comprise all the addresses of the chunks of the time range under consideration, that is to say of the past four hours, but only a portion of these addresses. Once the manifest has been received by the playback device, the first entity ENT1 accesses the manifest constructed according to the invention, and continues playback in restart mode from the playback instant specified beforehand from which a resumption of playback is desired (for example, 2 h 17 min 30 s in the past).

According to one embodiment, the server SRV will construct a manifest which comprises
a first portion MNFm (m is an integer) including addresses of chunks to be played back corresponding to the desired playback instant; this portion describes the 60 seconds of content corresponding to the desired playback instant (between 2 h 18 min 30 s and 2 h 17 min 30 s); this section can be identified with a manifest received during a normal playback of the content;
and at least one second portion (AD11/AD21; AD12/AD22).

The second portion, which can be written AD1i/AD2j (i and j being integers), can be the subject of variants described below.

According to a first variant, the second portion AD1i includes a set of addresses of chunks which are associated with the oldest sixty seconds of chunks which are available in the time window (or time range) under consideration; in the present example, this portion AD1i corresponds to the chunks which were transmitted about four hours ago. This variant makes it possible to go back in time as far as possible.

According to a second variant, the second portion AD2j includes a set of addresses of chunks AD2 corresponding to the stream broadcast live, i.e., in the present example, the 60 seconds of the most recent video chunks. The presence of this second portion AD2j in the second manifest is advantageous since the latter makes it possible to return to live without delay.

According to a third variant, the second portion combines the first and second variants. Here, the manifest created specifically for the restart mode comprises the addresses of chunks to be played back at the selected instant, and two portions AD1 and AD2 as described above.

Since the time window making it possible to play back the content in restart mode is fixed in the present example, each portion AD1i/MNFn/AD2j is updated during playback in restart mode.

The index “n” designates the manifest in the process of being played back;

The index “i” designates the ith update of the first portion AD1;

The index “j” designates the jth update of the portion AD2;

m, i, j being integers.

One embodiment of the method of the invention will now be described with reference to FIGS. 5, 6 and 7.

FIGS. 5 and 6 illustrate the state of playback at two distinct instants TA and TA′ (TA′>TA), respectively, during a playback phase in restart mode.

In FIGS. 5 and 6, the number of manifests which is used is very limited so as to disclose the invention simply.

FIGS. 5 and 6 each depict a first time axis LIV corresponding to a playback of content transmitted in real time (or live) and a second axis dedicated to the mode referred to as the restart mode RTP.

During the playback of the content in real time LIV, up to a current instant TC, four manifests MNF1-MNF4 are successively received by the playback device STB.

With reference to FIG. 5, it is assumed that, at the current instant TC, the “restart” mode RTP, described above, is activated and that an earlier instant TA than the current instant (TA<TC) is selected to continue playback in restart mode. A time jump (TC->TA), in a time window described with reference to FIG. 7, is then executed so as to resume playback at this earlier instant TA.

According to the invention, following the activation of the restart mode RTP described above, at the instant TC, the second entity ENT2 which is present on the server creates a manifest AD11/MNF2/AD21, referred to as the second manifest, which is specific to this playback mode referred to as the restart playback mode which comprises not only
the addresses of chunks to be played back corresponding to the instant TA as for playing back the content live, i.e. 60 seconds of content,
but also at least one other set of addresses of chunks, here two sets of addresses AD11 and AD21 according to the third variant described above.

This second manifest which is specific to the mode referred to as the restart mode may be denoted AD1i/MNFn/AD2j; it is updated over time with a time interval which is similar to that used for the stream transmitted live.

FIG. 6 illustrates the state of playback in restart mode at another, later time TA′ (TA′>TA). At this instant TA′, the server transmits a manifest AD12/MNF3/AD22.

FIG. 6 also shows that the manifests linked to the live stream continue to be transmitted in parallel. In the present example, a manifest MNF5 has been transmitted in connection with the live broadcast.

At each update, the addresses of chunks to be played back are updated; the portions AD1i and/or AD2j, according to the chosen variant, are also updated to respect the chosen time window for returning back through the content. Since the time window corresponds to a bounded time interval, the progression of the playback results in a modification of the bounds of the interval.

FIG. 7 illustrates the time window FT linked to the restart playback mode.

The time window FT is very useful for digital content referred to as live, i.e. which corresponds to real-time television programs; indeed, this content does not, by nature, have a predefined duration or end date. When the restart mode is executed, for example, at the instant TC1, a chunk can be selected in this window FT; likewise, if the restart mode is executed, for example, at the instant TC2, a chunk can be selected in this window FT which is shifted in time by a duration which is equal to TC2−TC1 (“−” is the mathematical sign corresponding to subtraction).

The time window is preferably of fixed duration. However, the duration of this time window may vary according to the use case.

FIG. 8 illustrates another embodiment illustrating the possibility of returning to live after a phase in restart mode.

This FIG. 8 comprises two axes which are representative of a playback device STB and of the content CNT server and of the exchanges of messages between these two devices.

The method comprises a first phase LIV of playing back a content transmitted in real time, a second phase RTP of playing back the content in restart mode and a third phase LIV of returning to real time.

During the first phase LIV, the playback device STB transmits a request REQ1 for access to content. In return, the content server SRV transmits at regular intervals, in the present example, manifests MNF1-MNFn, for example every 2 seconds.

At a given instant, the restart mode RTP is activated ACT. An earlier playback instant “TA” than the current instant “TC” (TA<TC) is selected so as to play back the content from the selected playback instant.

It is assumed that the instant TA corresponds to the instant at which the manifest MNF2 was transmitted earlier in connection with the content broadcast in real time.

A datum which is representative of the activation and the playback instant TA are transmitted by the playback device STB to the server and are received by the server SRV. These data can be conveyed by means of the same message or two distinct messages.

On receipt of the datum which is representative of an activation and of the selected playback instant TA which corresponds to the chunks which are described in the manifest MNF2, the server SRV creates a specific manifest AD11/MNF2/AD21 referred to as the second manifest. The second manifest is, for example, that described with reference to the third variant described above.

During this phase RTP, the server SRV transmits regular updates of the second manifests, namely AD12/MNF2/AD22 and AD13/MNF2/AD23. In the present example, the updates take into account the temporal displacement of the fixed time window, four hours in the present example; for example, the portion AD11 becomes AD12 during the update, then AD22 and so on.

Next, it is assumed that an address of chunks is selected SEL(AD23) from the set AD23 described above included in the second manifest. The selection SEL is transmitted by the playback device STB to the server SRV. This selection results in automatic transmission, by the server SRV, of a first manifest MNF10, instead of the second manifest of the type AD1i/MNFn/AD2j, for returning to the stream transmitted live. The server then continues the transmission of the first manifests, namely MNF11, etc. In other words, a selection of an address of chunks from the second manifest corresponding to an address which will be transmitted by the server for playing back the stream broadcast live is interpreted by the server as a desire to return to the real-time playback mode instead of the restart mode.

It has been seen above, in connection with the second variant, that the second manifest may comprise two portions of addresses, one targeting the oldest chunks, the other targeting the most recent, namely the chunks in the process of being broadcast in real time. These two portions and the instants of the associated chunks make it possible to construct a progress bar (or timeline) in order to locate the current playback instant in time and make it possible to select an earlier or later playback instant from this progress bar and to continue playback from the selected instant.

Lastly, it is also specified here that the term “entity” may correspond either to a software component or to a hardware component or to a set of hardware and software components, a software component itself corresponding to one or more computer programs or subprograms or, more generally, to any element of a program which is able to implement a function or a set of functions as described for the modules concerned. In the same way, a hardware component corresponds to any element of a hardware assembly which is able to implement a function or a set of functions for the module concerned (integrated circuit, chip card, memory card, etc.).

1. A management method implemented by a management entity device and comprising:
managing provision of manifests associated with chunks of chunked content, the manifests, referred to as first manifests, comprising addresses of chunks of the content and being successively transmitted one after the other with a view to being played back by a playback device, wherein the managing comprises:
during the transmission of the content in real time, receiving a command to perform a time jump in the content in order to play back the content from an earlier instant than the current playback instant; and
transmitting a second manifest comprising addresses of chunks to be played back at said earlier instant, which are supplemented by a portion of the addresses of chunks of the content already having been transmitted, the transmitting being triggered by the receiving.

2. The management method as claimed in claim 1, wherein the portion of addresses includes addresses of chunks transmitted in a last manifest, referred to as the first manifest, in connection with the real-time playback.

3. The management method as claimed in claim 1, wherein the portion of addresses of chunks includes chunks chosen from among the first chunks of the content.

4. The management method as claimed in claim 1, wherein the second manifest is updated over time, and wherein last addresses of chunks associated with the stream transmitted in real time are updated.

5. The management method as claimed in claim 2, comprising receiving a selection, from the second manifest, one of the last addresses of chunks and responsively transmitting the first manifest instead of the second manifest.

6. The management method as claimed in claim 1, wherein the earlier instant is selected in a given time window, and wherein said portion of the other addresses of chunks of the content having been transmitted originates from this time window.

7. The management method as claimed in claim 1, wherein the time window has a fixed duration.

8. A management entity device for managing provision of manifests associated with chunks of chunked content, the manifests, referred to as first manifests, comprising addresses of chunks of the content and being successively transmitted one after the other with a view to being played back by a playback device, wherein the management entity device comprises:
a microprocessor configured to, during the transmission of the content in real time receive a command to perform a time jump in the content in order to play back the content from an earlier instant than the current playback instant, and transmit a second manifest comprising addresses of chunks to be played back at said earlier instant, which are supplemented by a portion of the addresses of chunks of the content already having been transmitted, the transmitting being triggered by receiving the command.

9. A playback terminal comprising the management entity device as defined in claim 8.

10. (canceled)

11. A non-transitory computer readable data medium on which at least one series of program code instructions has been stored, which when executed by a management entity device configure the management entity device to manage provision of manifests associated with chunks of chunked content, the manifests, referred to as first manifests, comprising addresses of chunks of the content and being successively transmitted one after the other with a view to being played back by a playback device, wherein the managing comprises:
during the transmission of the content in real time, receiving a command to perform a time jump in the content in order to play back the content from an earlier instant than the current playback instant; and
transmitting a second manifest comprising addresses of chunks to be played back at said earlier instant, which are supplemented by a portion of the addresses of chunks of the content already having been transmitted, the transmitting being triggered by the receiving.
